(19) United States
(12) Patent Application Publication
(10) Pub. No.: US 2009/0299868 A1
(43) Pub. Date: Dec. 3, 2009

(54) METHOD AND SYSTEM FOR PROVIDING BID INFORMATION TO A USER IN RESPONSE TO A SERVICE REQUEST

(76) Inventor: Fiona O'Leary, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/431,413

(22) Filed: Apr. 28, 2009

Related U.S. Application Data
(60) Provisional application No. 61/048,864, filed on Apr. 29, 2008.

(51) Int. Cl. G06Q 30/00; G06F 15/16; G06Q 50/00

(52) U.S. Cl. 705/26; 709/206

(57) ABSTRACT

This disclosure generally relates to computer- and network-based methods and systems for providing bid information to a user in response to a service request in order to facilitate the selection of a preferred service provider. In some cases, bid information from each of a number of bids originating from a selection of service providers is presented in such a manner that a user is able to simultaneously view at least a portion of the bid information of each respective bid.

### CROSS-REFERENCE TO RELATED APPLICATION

This application claims the benefit under 35 U.S.C. § 119(e) of U.S. Provisional Patent Application No. 61/048,864 filed Apr. 29, 2008, which is hereby incorporated by reference in its entirety.

### BACKGROUND

1. Technical Field

The present disclosure relates generally to a method and system for providing bid information to a user, and particularly to a computer-implemented method and system for providing bid information to a user in response to a service request.

2. Description of the Related Art

There are numerous means available to consumers for locating service providers of desired services, as well as numerous methods for acquiring further information about such services in an attempt to obtain services upon mutually agreed terms and conditions.

For example, consumers may consult any number of service directories (e.g., the Yellow Pages) that list businesses (i.e., service providers) under various subject headings within a predefined geographic area. Consumers using such directories are often forced to flip through the pages of the directories (or search online directories) to locate a number of businesses providing a desired service. Limited information may be available about the desired service or the service provider, such as, for example, general pricing and availability. Often, however, there is not enough information provided to make an informed purchasing decision. As such, consumers are required to contact one or more service providers to request further information, including bids for desired services. In addition, for many services it is often desirable to contact multiple service providers to request a number of bids to determine whether any given bid is competitively priced. Furthermore, due to various limitations, such as, for example, availability of the service provider, availability of required resources to perform the services, and the location of the requested service, some service providers are unable to provide a bid or are otherwise unresponsive to bid requests. As such, much effort is expended and wasted in soliciting, collecting, evaluating and selecting bids in this way—ultimately leading to frustration and diminished satisfaction with the service acquisition process.

### BRIEF SUMMARY

Embodiments described herein provide enhanced computer- and network-based methods and systems for providing bid information to a user in response to a service request to facilitate the selection of a service provider.

A method for a computing system to dynamically provide bid information may be summarized as including receiving a service request from a user, the service request including service information indicative of at least a service type and a service description of a desired service; automatically assessing the service information to identify a plurality of service provider entries from multiple service provider entries correlating to the service type; providing at least a portion of the service information to a plurality of service provider computing systems corresponding respectively to the plurality of service provider entries; receiving from at least a portion of the plurality of service provider computing systems a plurality of bids, each bid including bid information indicative of at least a bid amount; and providing at least a portion of the bid information of each of the plurality of bids to a service requester computing system for simultaneous presentation of a plurality of summary lines containing information characteristic of each respective bid to the user.

Each of the plurality of summary lines may include at least the bid amount of each respective bid. The service information indicative of the service type may be derived from free-form text input by the user and automatically mapped to the service type. The method may further include receiving from a service provider computing system a supplemental information request; and providing at least a portion of the supplemental information request to the service requester computing system to enable the user to respond thereto. The service request may include service information indicative of an identity of the user. Automatically assessing the service information to identify a plurality of service provider entries from multiple service provider entries correlating to the service type may include automatically assessing the service information to identify the plurality of service provider entries from multiple service provider entries correlating to the service type and a service area. The service request may include service information indicative of a user location and a distance for determining the service area.

A computing system configured to provide bid information to a user to facilitate selection of a service provider may be summarized as including one or more processors and a bid service manager configured to, when executed by at least one of the one or more processors, facilitate selection of a service provider, by: receiving a service request from the user, the service request including service information indicative of at least a service type and a service description of a desired service; automatically assessing the service information to identify a plurality of service provider entries from multiple service provider entries correlating to the service type; providing at least a portion of the service information to a plurality of service provider computing systems corresponding respectively to the plurality of service provider entries; receiving from at least a portion of the plurality of service provider computing systems a plurality of bids, each bid including bid information indicative of at least a bid amount; and providing at least a portion of the bid information of each of the plurality of bids to a service requester computing system for simultaneous presentation of a plurality of summary lines containing information characteristic of each respective bid to the user.

A computer-readable medium may be summarized as including contents that configure a computing device to provide bid information to a user to facilitate selection of a service provider, by: receiving a service request from a user, the service request including service information indicative of at least a service type and a service description of a desired service; automatically assessing the service information to identify a plurality of service provider entries from multiple service provider entries correlating to the service type; providing at least a portion of the service information to a plurality of service provider computing systems corresponding respectively to the plurality of service provider entries; receiving from at least a portion of the plurality of service provider computing systems a plurality of bids, each bid including bid information indicative of at least a bid amount; and providing at least a portion of the bid information of each of the plurality of bids to a service requester computing system for simultaneous presentation of a plurality of summary lines containing information characteristic of each respective bid to the user.

The above may allow a user to solicit bids from a plurality of service providers in such a manner that the user may receive, compare and evaluate returned bids with minimal effort, thereby enabling the user to efficiently locate and select a preferred service provider for a desired service.

### BRIEF DESCRIPTION OF THE DRAWINGS

FIG. 1 is a network diagram illustrating an embodiment of a bid service for providing bid information to a user in response to a service request.

FIGS. 2A-2G illustrate screen shots of Web pages provided by a bid service manager to facilitate providing bid information to a user in response to a service request, according to one embodiment.

FIG. 3 is a block diagram illustrating example computing systems suitable for executing a bid service manager for providing bid information to a user in response to a service request.

FIG. 4 is a flow diagram showing a method of providing bid information in response to a service request, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment”, “in an embodiment”, or “in one or more embodiments” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Embodiments described herein provide enhanced computer- and network-based methods and systems for providing bid information to a user (or service requester) in response to a service request. Example embodiments provide a bid service, which enables a user to compare and evaluate bids collected from a plurality of service providers in response to a single service request. The bid service enables a user to input requested service information and submit a service request via a graphical user interface (GUI), the service information, according to one embodiment, being indicative of at least a service type (e.g., plumbing, yard maintenance, carpentry) and a service description (e.g., garbage disposal installation, tree pruning, deck construction) of the desired service.

Upon submittal, the bid service automatically assesses the submitted service information associated with the request to identify a plurality of service providers who may be capable of providing the desired service. Service providers can be identified by evaluating the service information and searching for correlating service providers from, for example, a database of service provider information gathered from service providers that have registered with the bid service or, as another example, other collections of service provider information from other sources (e.g., various trade association databases). The bid service then enables the identified service providers to access at least a portion of the service information such that any number of the identified service providers may evaluate the service information in order to formulate a bid containing bid information (e.g., bid amount, date service is to be completed, or other terms and conditions). The identified service providers (or a portion thereof) may then respond to the service request by submitting a bid or by requesting supplemental service information, preferably via a browser-based message system. The bid service enables the user to access received bids and supplemental information requests via a GUI, and with respect to the received bids, enables the user to simultaneously view at least a portion of the bid information to facilitate the user in efficiently comparing and evaluating bids to identify a preferred service provider for the desired service. As discussed in more detail below, in one illustrated embodiment, bid information is presented to a user via a browser-based message system such that the user can receive, organize and respond to a plurality of bid messages supplied by the bid service.

Although various embodiments are described herein in the context of a requested or desired “service,” it will be appreciated by those skilled in the art, that aspects of the various embodiments may be applied to a requested or desired “good.”

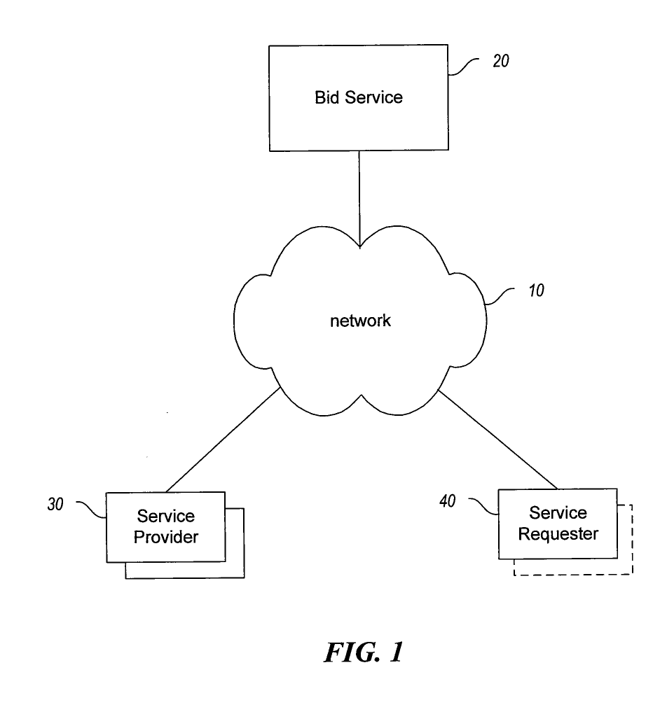

FIG. 1 is a network diagram illustrating an embodiment of a bid service for providing bid information to a service requester (also referred to as a user) in response to a service request. In particular, the illustrated example of FIG. 1 includes a number of service providers 30 and service requesters 40 that each interact with an embodiment of a bid service 20 via a network 10. The network 10 may, for example, be a publicly accessible network of linked networks, possibly operated by various distinct parties, such as the Internet, and may include various types of wired and/or wireless networks. In this illustrated example of FIG. 1, the service providers 30 and service requesters 40 may each use computing systems and/or devices (not shown) to interact with the bid service 20 to obtain various described functionality via the network 10, and in doing so may provide various types of indications or other information to the bid service 20. The interactions of the service providers 30 and service requesters 40 with the bid service 20 may occur in various ways in various embodiments, such as, for example, in an interactive manner via a GUI displayed on computing systems and/or other devices (not shown) of the service providers 30 and service requesters 40.

In this illustrated example, each of the service requesters 40 may interact with an embodiment of the bid service 20 to receive bid information from one or more of the service providers 30 that are automatically identified by the bid service 20 as those who may be able to provide a requested service. The identification of such service providers 30 is based at least in part on service information relating to the desired service that is supplied or otherwise indicated by the service requester 40, such as may include, for example, information indicative of a service type, a service description or a service area. To facilitate the service provider identification process, the bid service 20 of the illustrated embodiment includes or otherwise has access to various service provider information. For example, the bid service 20 may include or otherwise have access to a database and/or other data collection containing service provider information related to the services available from each service provider, such as may include information relating to service types, service descriptions, service areas, service availability and/or other information about the service provider and its services. In one embodiment, the bid service 20 includes a database of service provider entries based on information collected from service providers 30 who have registered with the bid service 20, each service provider entry containing at least service type information reflecting the types of services offered by the service provider.

As a further part of the service provider identification process, the bid service 20 assesses the service information associated with a particular service request and applies various techniques to identify a plurality of service providers (or service provider entries) correlating or relating to the service information, such as, for example, by cross referencing a database of service provider entries with the service information contained in the service request to identify one or more service provider entries containing service type information that correlates to the service type associated with the service request.

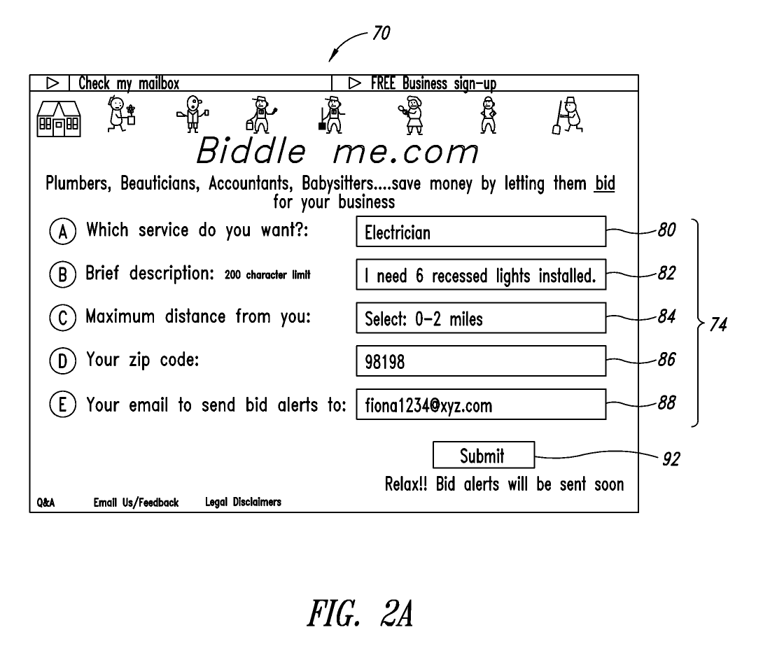

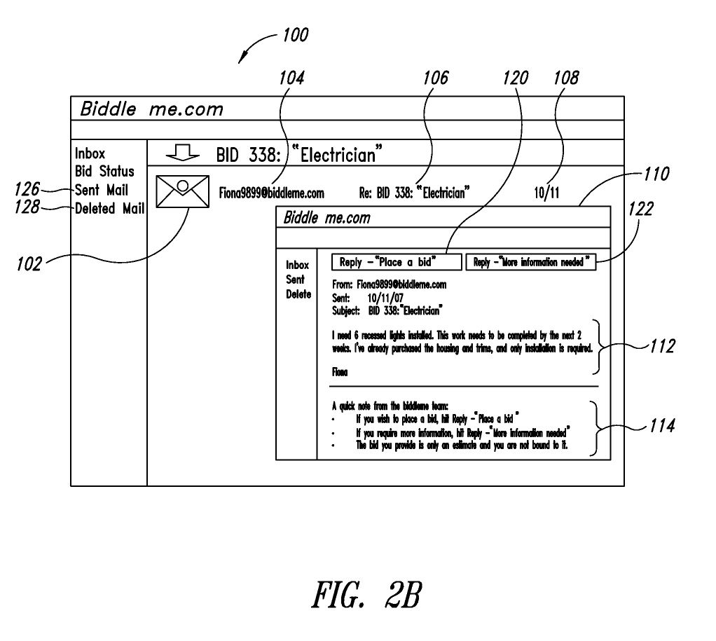

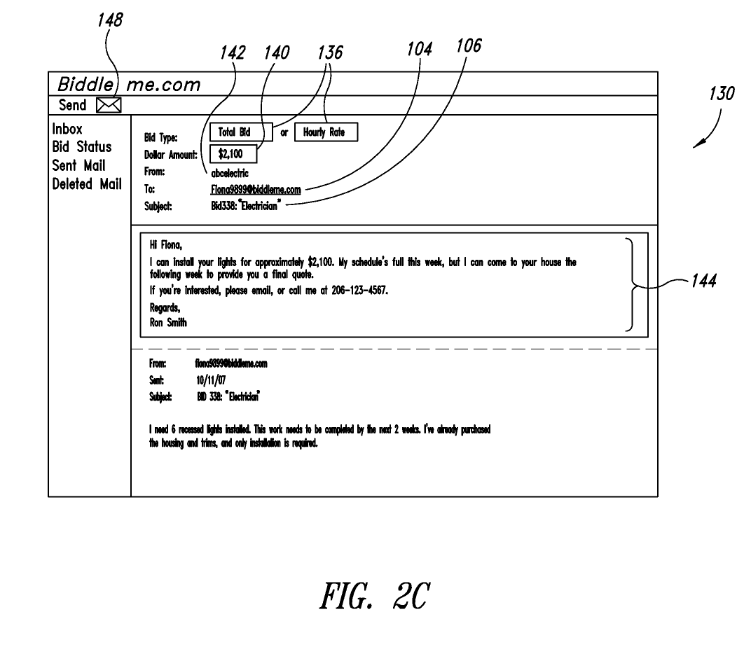

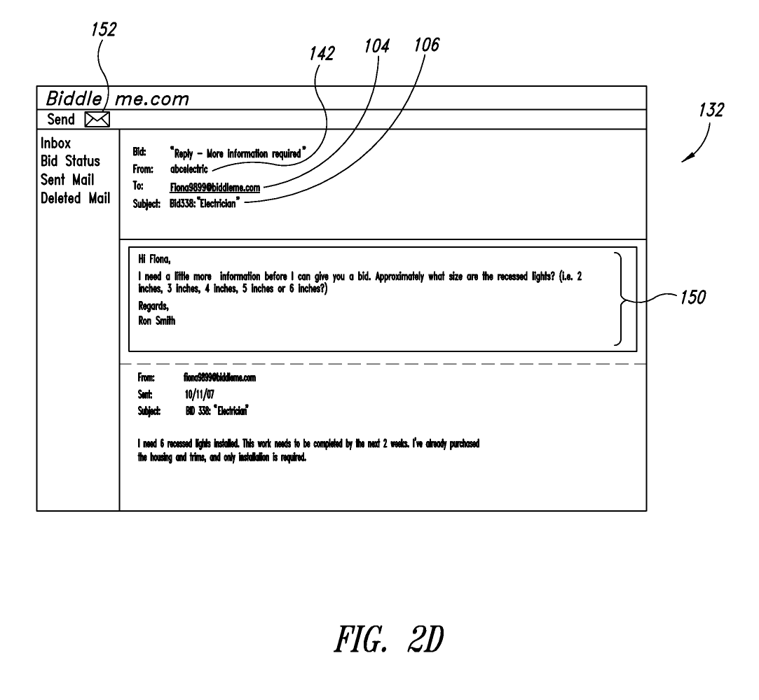

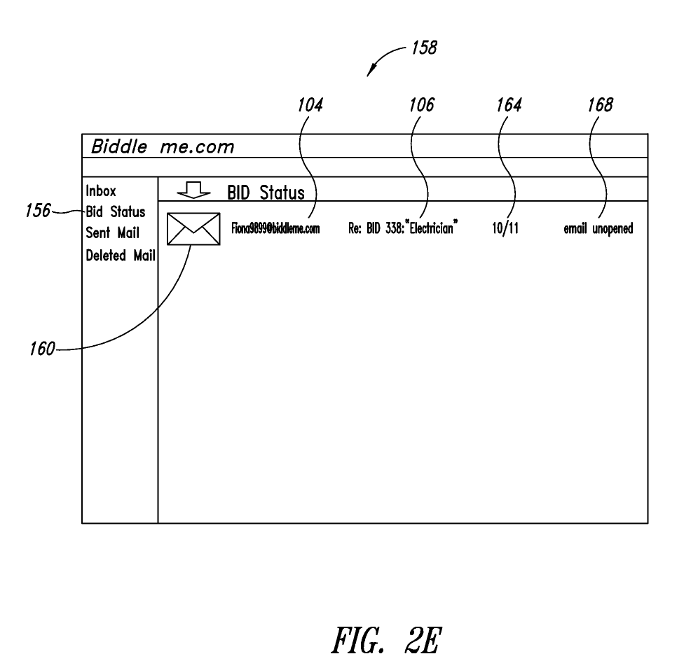

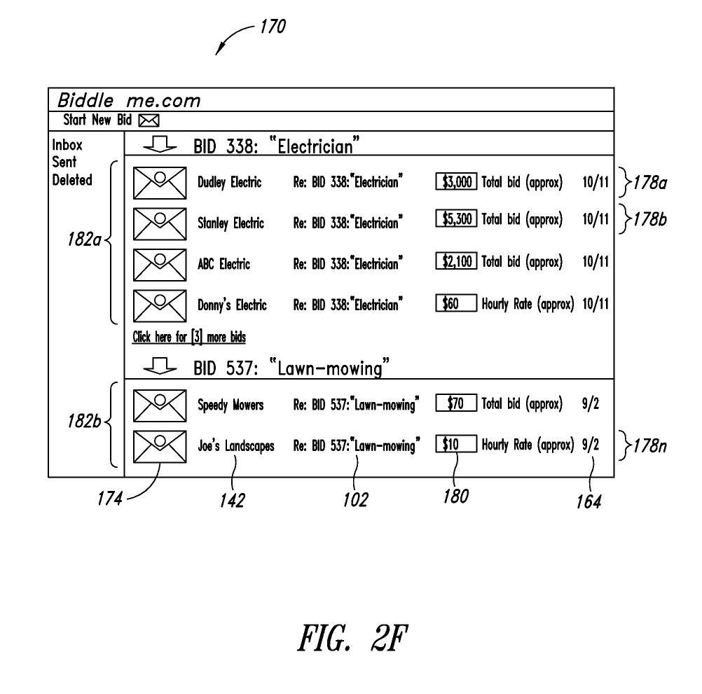

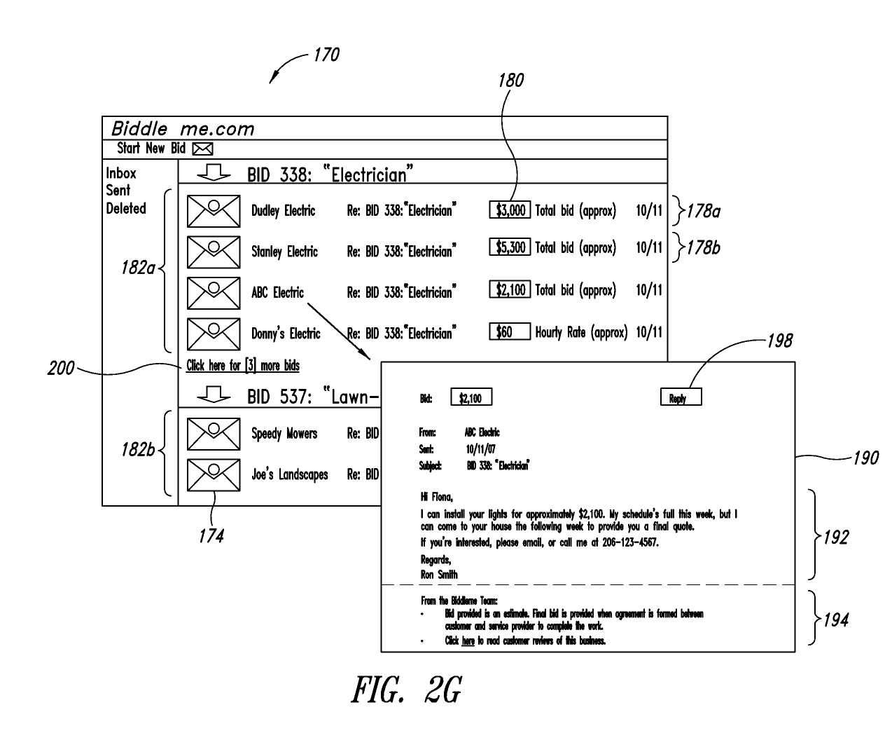

To facilitate the service provider identification process, the illustrated embodiment of the bid service 20 may provide for each of the interacting service requesters 40 a GUI that displays a number of service request fields and allows a service requester to select or input a variety of service information associated with a particular service request. For example, the service request fields may include a service type field having user-selectable controls that allow service requesters to select from a pre-defined list of services, allow service requesters to enter text relating to a desired service type in a free-form text box, or to input or otherwise provide an indication of a particular service type. As described in greater detail below with respect to the illustrated screen shots of FIGS. 2A-G, the provided GUI may include a limited number of service request fields and a control for submitting a service request that are displayed on a single user interface display such that the service requester can submit a service request with, for example, a single “click” of a mouse button.

After a service request is submitted, the service information associated therewith is provided to the bid service 20, such that the bid service 20 may use the service information to identify a number of service provider entries correlating to the requested service. For example, the bid service 20 may use the service information to identify a number of service provider entries associated with the same or a related service type as a service type of the requested service or, as another example, to identify a number of service provider entries associated with a service area that is within or overlaps with a preferred service area of the requested service. As a further example, the bid service 20 may assess the service information to identify one or more service descriptions associated with one or more service provider entries that correlates or is related to such service information. In this manner, a group or subgroup of service providers 30 may be identified that may be able to perform the requested service.

After identifying such service providers 30, the bid service 20 may provide for each of the identified service providers 30 a GUI that displays at least a portion of the service information of the requested service and allows each service provider 30 to respond thereto by submitting a bid or by requesting supplemental information. In at least one embodiment, the GUI of the bid service 20 may be provided in the form of one or more Web pages that are generated by the bid service 20, which may be obtained by various of the identified service providers 30 via the network 10, such as for display in a Web browser executing on one or more computing systems and/or devices of the identified service providers 30. For example, as described in greater detail below with respect to the illustrated screen shots of FIGS. 2A-G, in one embodiment, the provided GUI may be configured as a browser-based message system such that each of the identified service providers can receive, organize and respond to a plurality of service request messages in a convenient and efficient manner.

The bid service 20 receives and manages bids and supplemental information requests submitted by one or more of the identified service providers 30 such that a service requester 40 can access the service and interactively view any number of bids or supplemental information requests associated with the service request. For example, as described in greater detail below with respect to the illustrated screen shots of FIGS. 2A-G, in one embodiment, each of a plurality of received bids are simultaneously presented to the service requester as a plurality of summary lines containing information characteristic of each respective bid. In this manner, the service requester 40 can interact with the bid service 20 to receive, organize and evaluate a plurality of bids in an efficient manner and respond accordingly.

In various embodiments, the bid service GUI may be presented in various manners and may provide various types of additional and/or other interactivity and functionality for the service providers 30 and service requesters 40 (also referred to as users), with at least one illustrative example embodiment of such a GUI being described below with respect to FIGS. 2A-2G.

FIG. 2A illustrates a service request input interface 70 of the bid service GUI, which provides an interface for soliciting bids by receiving service information associated with a requested service from a user (or service requester). In order to receive the service information, the input interface 70 includes a number of service request fields 74 that enable a user to select or input various service information associated with a particular service request. For example, the service request fields 74 may include a service type field 80, a service description field 82, a distance field 84, a user location field 86 and a user identifier field 88 that respectively correspond to locations for inputting or receiving an indication of service information indicative of a service type, a service description, a service area, a user location and a user identity. In this manner, the service type field 80 enables a user to provide an indication of a certain type of desired service, such as, for example, plumbing or electrician services. The service description field 82 allows a user to provide an indication of the requested services to be performed, such as, for example, the installation of a garbage disposal or the installation of recessed lights. The distance field 84 allows a user to provide an indication of a preferred service area, if any, such as, for example, within the limits of a particular city or within a particular distance of the user. The user location field 86 allows a user to provide an indication of the user's location which may be used alone or in conjunction with information from the distance field 84 to determine the service area. The user identifier field 88 allows a user to provide an indication of a user identity to facilitate communication between the bid service and the user.

The service request fields 74 may have user-selectable controls that allow the user to select from a pre-defined list of entries, such as a list of service types, or may include a free-form text box for inputting unrestricted or partially restricted text. For example, according to the illustrated embodiment, the bid service enables a user to input free-form text in the service type field 80, which is subsequently automatically mapped to a service type by the bid service. Utilizing a free-form text box enables a significantly larger scope of service types by allowing the user to input unrestricted service type information that may then be mapped, for example, to a database containing thousands of service provider types.

Although the illustrated embodiment includes five service request fields 74, more or less service request fields may be provided. For example, some embodiments may omit the distance field 84 and some embodiments may include additional service request fields, such as, for example, a service request field for indicating a requested completion date.

In accordance with the illustrated embodiment, the input interface 70 also includes a user-selectable control 92 for submitting the service request. Upon activation of the control 92, various checking processes may be performed by the bid service, such as, for example, a spell checking process to improve recognition of the supplied service information or a compliance check to verify that the service information meets certain conditions, such as a character limit or various format requirements. After activation of the control 92, the service information of the service request is automatically assessed by the bid service to identify service providers who may be able to provide the requested service, as described in more detail elsewhere.

According to one illustrated embodiment, the bid service provides an input interface 70 that enables a user to input a service request within the confines of a single Web page and submit the service request with a single “click” of a mouse button. For example, as illustrated in FIG. 2A, the user may interact with the bid service GUI to input “Electrician” in the service type field 80, “I need 6 recessed lights installed” in the service description field 82, “0-2 miles” in the distance field 84, the zip code “98198” in the user location field 86 and the email address “fiona1234@xyz.com” in the user identifier field 88, and submit the service request with a “click” of user-selectable control 92. In this manner, a user can conveniently solicit a plurality of bids from any number of service providers with minimal effort.

As described earlier, after a user submits a service request, the service information is assessed against a database (or other data collection) of service provider entries to identify a group or subgroup of service providers capable of performing the requested service. Each service provider in the group or subgroup, or a portion thereof, is then sent a message notifying each potential bidder (i.e., service provider) of the service request. The service providers are then provided with means of responding to the service request, as described in more detail below.

FIG. 2B illustrates a screen shot of a service provider inbox 100 provided by the bid service GUI that functions as part of a browser-based message system. More particularly, FIG. 2B illustrates that an example service provider has received a service request message 102 generated by the bid service in response to a service request by a user. The service request message 102 is displayed to the service provider as a summary line containing various information related to the service request, including a user identifier 104 (e.g., a user address or user code), a bid request identifier 106 (e.g., a bid number, bid title or combination thereof) and a bid request date 108. This information provides means for identifying and tracking the service request message 102, as well as means for arranging and organizing the service request message 102 amongst other service request messages (none shown) that may be similarly located in the service provider inbox 100.

As shown in the illustrated embodiment, the service provider may select and open a service request message 102 to view and evaluate the contents of the service request message 102 in a message display window 110. The contents of the service request message 102 are generated by the bid service based at least in part on the service information provided by the user as discussed above. For example, service information descriptive of a requested service obtained via the service description field 82 of input interface 70 is used to populate a portion 112 of the service request message 102. The service request message 102 may also contain various other information at another portion 114 of the message, such as, for example, bid instruction information for instructing the service provider of various response options. For responding to the service request message 102, the service provider may be provided with an interactive bid submittal message 130 (as illustrated in FIG. 2C) by activating a first reply control 120 or may be provided with an interactive supplemental information request message 132 (as illustrated in FIG. 2D) by activating a second reply control 122. If the service provider does not wish to submit a bid or otherwise respond to the service request message 102, the service provider may simply delete the service request message 102. As can be appreciated from FIG. 2B, many of the functionalities of conventional email systems, such as controls to enable the user to review sent messages or deleted messages (e.g., sent mail link 126 and deleted mail link 128) may be provided but are not discussed in detail for the sake of brevity.

As stated earlier, if the service provider wants to submit a bid, the service provider may activate first reply control 120 to cause the bid service to generate an interactive bid submittal message 130, as illustrated in FIG. 2C. The bid submittal message 130 is populated with at least a bid amount field 140 for receiving bid information indicative of a bid amount. The bid amount field 140 may limit a service provider to inputting or selecting bid information indicative of a fixed amount (e.g., $2,100) or an hourly rate (e.g., $40/hour), however, it is appreciated that, according to some embodiments, a finite range (e.g., $300-400) may be input or selected by the service provider. Alternatively, as shown in the illustrated embodiment, separate user-selectable controls 136 may be presented to the service provider for providing an indication of whether the bid information input to or otherwise selected from the bid amount field 140 is indicative of a bid amount having a fixed amount or an hourly rate. In other embodiments, the bid amount may include an indicating feature, such as, for example, an asterisk to indicate that the bid includes limitations, restrictions or clarifications. For example, an asterisk may indicate the presence of qualifying language such as “bid is for labor only, you supply materials.” Further bid information, such as, for example, general service availability, service provider contact information, and the like may be received in the body 144 of the bid submittal message 130. The bid submittal message 130 is also preferably populated with various other identification information, such as a service provider identifier 142 and the user and bid request identifiers 104, 106. After the service provider inputs or otherwise selects bid information by interacting with the bid submittal message 130, the message may be processed or “sent” by activating a send control 148. In this manner, the service provider is able to efficiently provide a bid in response to the service request.

As indicated above, a service provider may be provided with an interactive supplemental information request message 132, as illustrated in FIG. 2D, by activating a second reply control 122 contained in the service request message 102. In this manner, the service provider can conveniently request additional service information prior to submitting a bid. As shown in the illustrated embodiment, the supplemental information request message 132 is automatically populated with various identification information, such as service provider identifier 142, user identifier 104 and bid request identifier 106, and enables the service provider to input a supplemental information request in the body 150 of the message. The supplemental information request message 132 may be processed or “sent” by activating a send control 152, after which at least a portion of the supplemental information request is made accessible to the service requester computing system to enable the user to respond thereto. In this manner, the bid service facilitates subsequent communications between the user and a particular service provider for the purpose of exchanging additional service and/or bid information. If, after receiving a response to a supplemental information request, the service provider wishes to provide a bid, the service provider may do so by activating a control to cause the bid service to generate a bid submittal message, as described above.

With reference to FIG. 2E, after submitting one or more bids, a service provider may review the status of any submitted bids by activating a bid status link 156 to cause the bid service to generate a bid status page 158. As shown in the illustrated embodiment, a submitted bid 160 listed on the bid status page 158 may be displayed as a summary line containing various information related to the submitted bid 160, including a user identifier 104, a bid request identifier 106, a bid submittal date 164 and a bid status indicator 168 (e.g., “pending” or “unopened”). This information provides means for identifying and tracking each submitted bid 160, as well as means for arranging and organizing the submitted bid 160 amongst other submitted bids that may be similarly displayed within the bid status page 158. For example, submitted bids 160 may be sorted or filtered by the bid status indicator 168, such as by limiting the displayed bids to those bids having a status of “pending” or “unopened.” In one embodiment, submitted bids are automatically deleted and removed from the bid status page 158 when a user accepts a bid from a third-party service provider.

FIG. 2F illustrates a screen shot of a service requester inbox 170 generated by the bid service GUI that functions as part of a browser-based message system. More particularly, FIG. 2F illustrates that an example user (or service requester) has received a number of bid messages 174 that are simultaneously displayed as summary lines 178a, 178b . . . 178n that contain bid information indicative of at least a bid amount. For example, the service requester inbox 170 shows four bid messages 174 received in response to the requested service identified as BID 338: “Electrician” and two bid messages received in response to requested service identified as BID 537: “Lawn-mowing” services. Various information is displayed in connection with each bid message 174 in respective summary lines 178a, 178b . . . 178n, including at least a bid amount shown in bid display field 180. Other displayed information may include the service provider identifier 142, bid request identifier 106, and the bid submittal date 164. This information provides means for identifying and tracking the bid messages 174, as well as means for arranging and organizing the bid messages 174. For example, the user may cause the bid service to arrange all summary lines 178a, 178b . . . 178n or a subset thereof 182a, 182b based on an ascending or descending bid amount. It is preferable that only the information most often decisive to selecting a service provider (e.g., bid amount) be provided in the summary line of each displayed bid to reduce complexity and facilitate efficient use of the bid service. A user can then access any additional bid information that may be associated with the bid message 174 by selecting the bid message, such as, for example, by “double clicking” a mouse button on one of the summary lines 178a, 178b . . . 178n, thereby causing the bid service to present a detail window 190 containing the body 192 of the bid message 174, as illustrated in FIG. 2G. The detail window 190 may contain additional information such as standard instructions, procedures, warnings and other information to facilitate the bid selection process. For example, a warning may be provided to remind users that the supplied bids are estimates and do not form binding agreements, as shown in a bottom portion 194 of the illustrated detail window 190. The detail window 190 may also provide information about the service provider, such as, for example, consumer reviews of the service provider, representative samples of proposed services from prior performed services, or a link to the service provider's website.

Means are provided for replying to each bid message 174 to obtain additional or clarifying information or to indicate a willingness to enter a service agreement. For example, a reply control 198 may be located within the detail window for responding to the bid message. A reply button or other method for replying may also be provided within each of the summary lines 178a, 178b . . . 178n to facilitate responding to the message without the intermediate step of opening the detail window 190.

According to the illustrated embodiment, some bid messages 174 may be hidden from view and revealed by the bid service upon the user activating an appropriate control 200, such as, for example, activating the illustrated link “Click here for [3] more bids.” As illustrated, the control 200 may include an indication of how many bid messages have been temporarily hidden from view.

Various data is tracked in conjunction with embodiments of the bid service described herein. For example, the number of bids placed by a service provider may be tracked by the bid service to facilitate billing the service provider and/or providing performance statistics. For example, service providers may be billed a nominal fee each time a service provider places a bid and/or may be billed each time a user opens a bid message. Alternatively, a provider may be charged a flat fee or a monthly fee for a set number of bids-per-month or for unlimited bid submittal privileges. No matter the billing structure, it is desirous to collect bid data to track use of the bid service. Bid data can be used to provide performance feedback to service providers, such as, for example, a success rate in the form of number of successful bids per bids submitted.

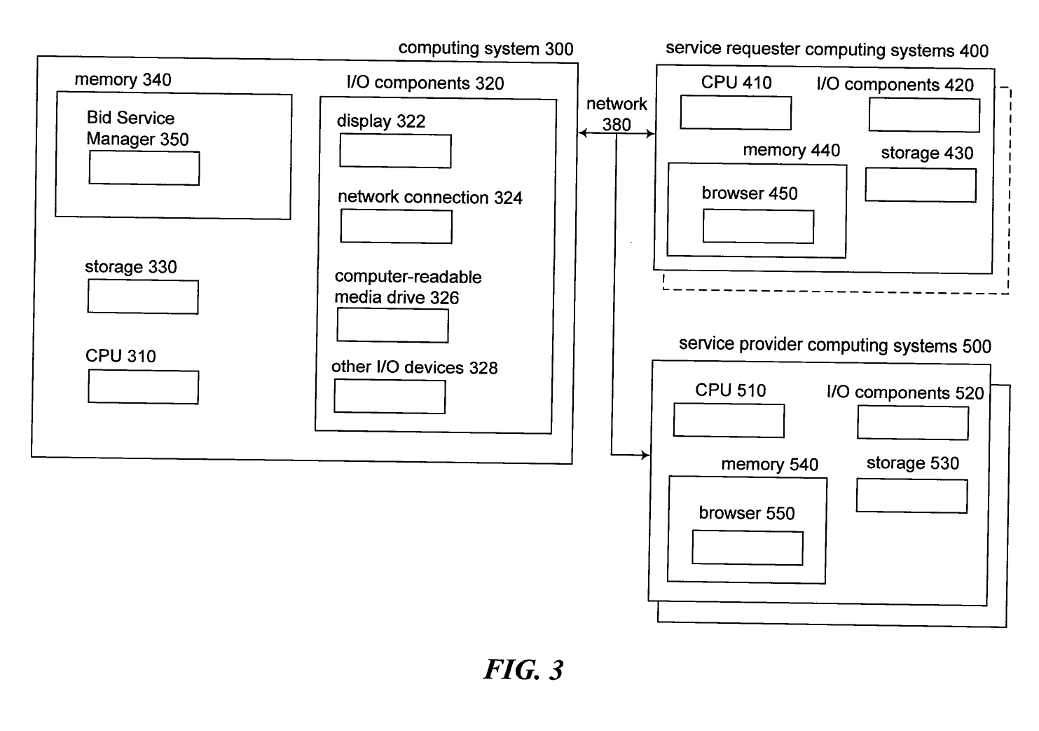

FIG. 3 is a block diagram illustrating an example embodiment of a bid service system for providing bid information to a user in response to a service request. In particular, FIG. 3 illustrates a server computing system 300 suitable for executing an embodiment of a Bid Service Manager 350 and service requester computing systems 400 and service provider computing systems 500, which may interact with the Bid Service Manager 350. In the illustrated embodiment, the server computing system 300 has components that include a CPU 310, various I/O components 320, storage 330, and memory 340. The illustrated I/O components include a display 322, a network connection 324, a computer-readable media drive 326, and other I/O devices 328 (e.g., a keyboard, a mouse, speakers, etc.). In addition, the illustrated service requester computing systems 400 have components similar to those of server computing system 300, including a CPU 410, I/O components 420 (although particular components are not illustrated), storage 430, and memory 440. Similarly, the service provider computing systems 500 may also each include similar components to some or all of the components illustrated with respect to the computing system 300, such as CPU 510, I/O components 520, storage 530, and memory 540.

An embodiment of the Bid Service Manager 350 is executing in memory 340, such as under control of configured CPU 310, and it may interact with the service requester computing systems 400 and service provider computing systems 500 over the network 380 (e.g., via the Internet). In this example embodiment, the Bid Service Manager 350 includes functionality related to receiving, in response to a service request, bids or bid information from a plurality of service providers (not shown) who are interacting with the service provider computing systems 500 and providing bids or bid information to service requesters (also referred to as users) who are interacting with the service requester computing systems 400.

The service requester computing systems 400 and service provider computing systems 500 may have various forms, and may be executing various software as part of interactions with the Bid Service Manager 350. For example, service requester computing systems 400 may include various types of client devices (e.g., a desktop computing system, a portable computing system, a smartphone or other cell phone or other mobile device that includes appropriate communication and computing capabilities), and in the illustrated embodiment are shown executing a Web browser 450 or other software (e.g., a module of the Bid Service Manager that is designed to execute on a client device) in memory 440 to interact with the Bid Service Manager 350. Likewise, the service provider computing systems 500 may include various types of client devices, and in the illustrated embodiment are shown executing a Web browser 550 or other software in memory 540 to interact with the Bid Service Manager 350.

The Web browser 450 or other software on a service requester computing system 400 interacts with the Bid Service Manager (or module thereof) to provide service information about a desired service in various ways, as well as to obtain a plurality of bids or bid information in response to a service request. For example, the Web browser 450 or other software on the service requester computing system 400 may display or otherwise present (e.g., via a GUI of the Bid Service Manager 350 that is displayed to the service requester via one or more Web pages or other UI screens on the service requester computing system 400) an interface for receiving service request information via a plurality of input fields or selectable controls, which enable the service requester to specify a desired service and request bids or bid information from various service providers. Service requesters (or users) of the service requester computing systems 400 may also interact with the Bid Service Manager 350 to receive bids or bid information via the Web Browser 450 or other software, such as, for example, receiving bids via a number of bid messages generated as a part of the browser-based message system described above in connection with FIGS. 2A-2G. In addition, one or more service requesters may interact with Bid Service Manager 350 via service requester computing systems 400 to perform various other types of actions, as discussed in greater detail elsewhere.

The Web browser 550 or other software on a service provider computing system 500 interacts with the Bid Service Manager (or a module thereof) to receive service requests in various ways, as well as to provide bids in response to such requests. For example, the Web browser 550 or other software on the service provider computing system 500 may display or otherwise present an interface for viewing service information about a requested service, such as, for example, displaying service request messages containing such information as a part of a browser-based message system. Service providers may also interact with the Bid Service Manager 350 via service provider computing systems 500 to provide information about the service provider and its offered services (e.g., service provider contact information, types of services offered, descriptions of services offered), which may be stored, for example, in storage 330 (such as in a service provider database) for facilitating the identification of service providers who may be able to provide certain requested services. In addition, one or more service providers may interact with Bid Service Manager 350 via service provider computing systems 500 to perform various other types of actions, as discussed in greater detail elsewhere.

After the Bid Service Manager 350 receives a submitted service request, the Bid Service Manager 350 may automatically assess the service information (e.g., service type information, service description information) contained in the request to identify a plurality of service providers who may be able to perform the service. For example, as discussed previously, the service information may be compared with or cross-referenced against a database or other collection of service provider entries containing service provider information.

After the Bid Service Manager 350 identifies service providers who may be able to perform the requested service by assessing the service information and locating a number of service provider entries having information correlating to or related to the requested service, such as, for example, a same or similar service type, the Bid Service Manager 350 may then incorporate some or all of the service information into a form to be provided to one or more of the service providers for display or other presentation, such as in one or more Web pages to be displayed on respective service provider computing systems of the one or more service providers. In one embodiment, the Bid Service Manager 350 displays service request messages 102 containing service information as a part of a browser-based message system, such as illustrated in FIG. 2B. As discussed in greater detail elsewhere, the Bid Service Manager 350 enables the identified service providers to respond to service requests by supplying bids or requesting additional service information, such as, for example, by generating an interactive bid submittal message 130 (as illustrated in FIG. 2C) or supplemental information request message 132 (as illustrated in FIG. 2D). In turn, the Bid Service Manager 350 enables the service requester to receive and view bids or supplemental information requests and respond to the same, such as, for example, by generating bid messages 174 that are simultaneously displayed as summary lines 178a, 178b . . . 178n in a service requester inbox 170, as illustrated in FIG. 2F. In addition, the Bid Service Manager 350 provides various other functionality in connection with providing bid information to facilitate the selection of a preferred service provider for the requested service, as discussed in greater detail elsewhere.

It will be appreciated that computing systems 300, 400 and 500 are merely illustrative and are not intended to limit the scope of the present invention. The computing systems 300, 400 and 500 may instead each include multiple interacting computing systems or devices, and the computing systems 300, 400 and 500 may be connected to other devices that are not illustrated, including through one or more networks, such as the Internet. More generally, a computing device or other computing system may comprise any combination of hardware or software that may interact and perform the described types of functionality, including without limitation, desktop or other computers, database servers, network storage devices and other network devices, PDAs, cellphones, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated Bid Service Manager 350 may in some embodiments be distributed in various modules. Similarly, in some embodiments some of the functionality of the Bid Service Manager 350 may not be provided and/or other additional functionality may be available.

It will also be appreciated that, while the Bid Service Manager 350 and modules thereof are described as being stored in memory or on storage while being used, the Bid Service Manager 350 and/or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other manners, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

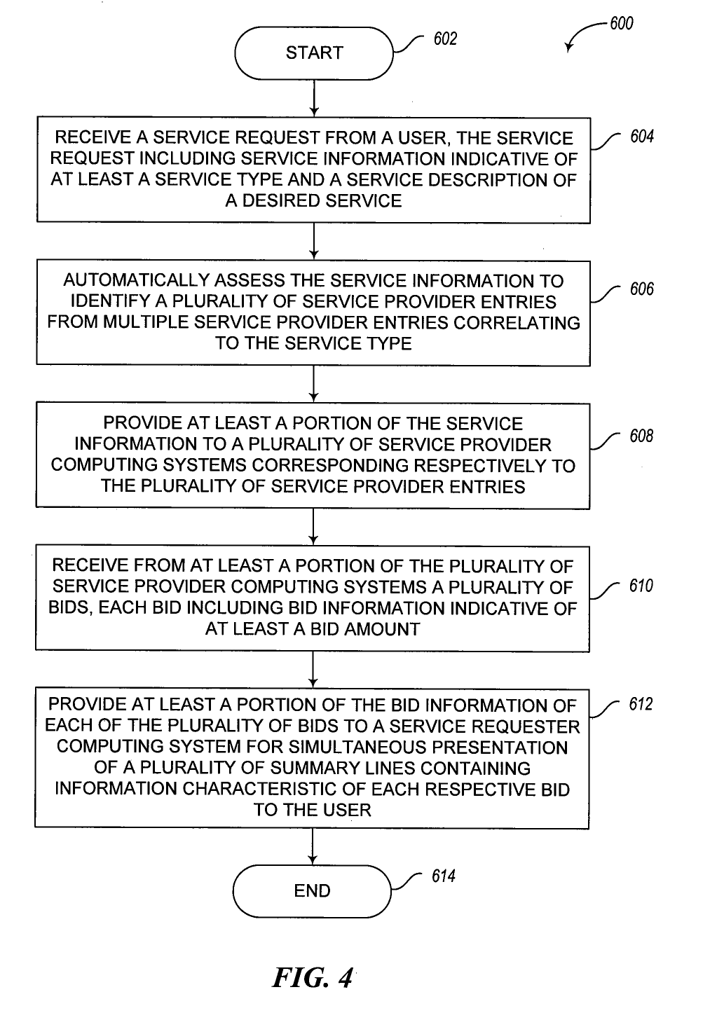

FIG. 4 shows an example method 600 of providing bid information in response to a service request. The method 600 may be implemented, for example, by the Bid Service Manager 350 shown in FIG. 3 and/or as part of the bid service 20 of FIG. 1.

The method starts at 602, such as in response to an indication to solicit bids.

At 604, the bid service receives a service request from a user, the service request including service information indicative of at least a service type and a service description of a desired service.

At 606, the bid service automatically assesses the service information to identify a plurality of service provider entries from multiple service provider entries correlating to the service type of the desired service.

At 608, the bid service provides at least a portion of the service information to a plurality of service provider computing systems corresponding respectively to the plurality of service provider entries.

At 610, the bid service receives from at least a portion of the plurality of service provider computing systems a plurality of bids, each bid including bid information indicative of at least a bid amount.

At 612, the bid service provides at least a portion of the bid information of each of the plurality of bids to a service requester computing system for simultaneous presentation of a plurality of summary lines containing information characteristic of each respective bid to the user.

The method 600 terminates at 614. The method may terminate, for example, upon providing the bid information. Alternatively, the method 600 may repeat by returning to 604.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for a computing system to dynamically provide bid information, the method comprising:
under the control of one or more configured computing systems,
receiving a service request from a user, the service request including service information indicative of at least a service type and a service description of a desired service;
automatically assessing the service information to identify a plurality of service provider entries from multiple service provider entries correlating to the service type;
providing at least a portion of the service information to a plurality of service provider computing systems corresponding respectively to the plurality of service provider entries;
receiving from at least a portion of the plurality of service provider computing systems a plurality of bids, each bid including bid information indicative of at least a bid amount; and
providing at least a portion of the bid information of each of the plurality of bids to a service requester computing system for simultaneous presentation of a plurality of summary lines containing information characteristic of each respective bid to the user.

2. The method of claim 1 wherein each of the plurality of summary lines includes at least the bid amount of each respective bid.

3. The method of claim 1 wherein the service information indicative of the service type is derived from free-form text input by the user and automatically mapped to the service type.

4. The method of claim 1, further comprising:
receiving from a service provider computing system a supplemental information request; and
providing at least a portion of the supplemental information request to the service requester computing system to enable the user to respond thereto.

5. The method of claim 1 wherein the service request includes service information indicative of an identity of the user.

6. The method of claim 1 wherein automatically assessing the service information to identify a plurality of service provider entries from multiple service provider entries correlating to the service type includes automatically assessing the service information to identify the plurality of service provider entries from multiple service provider entries correlating to the service type and a service area.

7. The method of claim 6 wherein the service request includes service information indicative of a user location and a distance for determining the service area.

8. A method for a computing system to provide bid information to a user to facilitate the selection of a service provider, the method comprising:
under the control of one or more configured computing systems,
providing a Web page for use in displaying to the user a plurality of service request fields, the Web page including instructions to display at least a service type field and a service description field and a control for submitting a service request based on interactions of the user with the Web page;
receiving the service request from the user, the service request including service information that reflects at least a service type and a service description of a desired service;
automatically determining a plurality of service provider entries from multiple service provider entries correlating to the service type;
providing at least a portion of the service information to a plurality of service provider computing systems corresponding respectively to the plurality of service provider entries;
receiving a bid from each of at least a portion of the plurality of service provider computing systems, each bid including bid information that includes at least a bid amount; and
providing at least a portion of the bid information of each bid to a service requester computing system for simultaneous presentation of the bid amount of each bid to the user.

9. The method of claim 8 wherein the service request includes service information indicative of an identity of the user.

10. The method of claim 8 wherein the service information indicative of the service type is derived from free-form text input by the user and automatically mapped to the service type.

11. The method of claim 8 wherein automatically determining a plurality of service provider entries from multiple service provider entries correlating to the service type includes determining the plurality of service provider entries from multiple service provider entries correlating to the service type and a service area.

12. The method of claim 11 wherein the service request includes service information indicative of a user location and a distance for determining the service area.

13. A method for a computing system to provide bid information to a user to facilitate selection of a service provider, the method comprising:
under the control of one or more configured computing systems,
providing a Web page for use in displaying a plurality of service request fields, the Web page including a control for submitting a service request;
receiving the service request from the user, the service request including service information that reflects at least a service type and a service description of a desired service;
automatically determining a plurality of service provider entries from multiple service provider entries correlating to the service type;
automatically generating a service request message for use in displaying at least a portion of the service information on a service provider computing system corresponding to one of the plurality of service provider entries; and
after providing the service request message to the service provider computing system and after receiving a bid having bid information that reflects at least a bid amount,
providing at least a portion of the bid information to a service requester computing system for presentation of a bid message summary line containing information characteristic of the bid to the user.

14. The method of claim 13 wherein the bid message summary line includes at least the bid amount of the bid.

15. The method of claim 13 wherein the service request includes service information indicative of an identity of the user.

16. The method of claim 13 wherein the service information indicative of the service type is derived from free-form text input by the user and automatically mapped to the service type.

17. The method of claim 13 wherein the service request message includes at least a first reply control and a second reply control, the first reply control configured to cause the generation of a interactive bid submittal message for submitting the bid and the second reply control configured to cause the generation of an interactive supplemental information request message for requesting supplemental service information.

18. The method of claim 13 wherein automatically determining a plurality of service provider entries from multiple service provider entries correlating to the service type includes determining the plurality of service provider entries from multiple service provider entries correlating to the service type and a service area.

19. The method of claim 18 wherein the service request includes service information indicative of a user location and a distance for determining the service area.

20. A computing system configured to provide bid information to a user, comprising:
one or more processors; and
a bid service manager configured to, when executed by at least one of the one or more processors, facilitate selection of a service provider, by:
receiving a service request from the user, the service request including service information indicative of at least a service type and a service description of a desired service;
automatically assessing the service information to identify a plurality of service provider entries from multiple service provider entries correlating to the service type;
providing at least a portion of the service information to a plurality of service provider computing systems corresponding respectively to the plurality of service provider entries;
receiving from at least a portion of the plurality of service provider computing systems a plurality of bids, each bid including bid information indicative of at least a bid amount; and
providing at least a portion of the bid information of each of the plurality of bids to a service requester computing system for simultaneous presentation of a plurality of summary lines containing information characteristic of each respective bid to the user.

21. The computing system of claim 20 wherein each of the plurality of summary lines includes at least the bid amount of each respective bid.

22. The computing system of claim 20 wherein the service information indicative of the service type is derived from free-form text input by the user and automatically mapped to the service type.

23. The computing system of claim 20 wherein the bid service manager is further configured to, when executed by at least one of the one or more processors, facilitate selection of a service provider, by:
receiving from a service provider computing system a supplemental information request; and
providing at least a portion of the supplemental information request to the service requester computing system to enable the user to respond thereto.

24. The computing system of claim 20 wherein the service request includes service information indicative of an identity of the user.

25. The computing system of claim 20 wherein automatically assessing the service information to identify a plurality of service provider entries from multiple service provider entries correlating to the service type includes automatically assessing the service information to identify the plurality of service provider entries from multiple service provider entries correlating to the service type and a service area.

26. The computing system of claim 25 wherein the service request includes service information indicative of a user location and a distance for determining the service area.

27. A computer-readable medium whose contents configure a computing device to provide bid information to a user to facilitate selection of a service provider, by performing a method comprising:
receiving a service request from the user, the service request including service information indicative of at least a service type and a service description of a desired service;
automatically assessing the service information to identify a plurality of service provider entries from multiple service provider entries correlating to the service type;
providing at least a portion of the service information to a plurality of service provider computing systems corresponding respectively to the plurality of service provider entries;
receiving from at least a portion of the plurality of service provider computing systems a plurality of bids, each bid including bid information indicative of at least a bid amount; and
providing at least a portion of the bid information of each of the plurality of bids to a service requester computing system for simultaneous presentation of a plurality of summary lines containing information characteristic of each respective bid to the user.
